(19) United States
(12) Patent Application Publication
(10) Pub. No.: US 2014/0367234 A1
(43) Pub. Date: Dec. 18, 2014

(54) DUST AND WATERPROOF SWITCH

(71) Applicant: EAO Automotive GmbH & Co. KG, Auerbach (DE)

(72) Inventor: Bernd Ebert, Rodewisch (DE)

(73) Assignee: EAO Automotive GmbH & Co. KG, Auerbach (DE)

(21) Appl. No.: 14/348,984

(22) PCT Filed: Feb. 8, 2013
(86) PCT No.: PCT/DE2013/000070

§ 371 Date: Apr. 1, 2014

(30) Foreign Application Priority Data
Feb. 27, 2012 (DE) 20 2012 001 867.1

(51) Int. Cl. H01H 9/16; H01H 3/38; H01H 9/04; H01H 9/20; B60R 22/00; H01H 1/36

(52) U.S. Cl. CPC H01H 9/16; B60R 22/00; H01H 1/36; H01H 9/04; H01H 9/20; H01H 3/38; H01H 2203/00
USPC 200/61.58 B

(57) ABSTRACT

A dustproof and waterproof switch, in particular for a seat belt buckle of restraint systems of motor vehicles for indicating that the latch plate has been inserted into the seat belt buckle and properly locked, includes two contact plates, composed of a fixed contact plate and a contact spring plate, wherein the contacting regions of the contact plates are disposed in a housing-interior of the switch housing which is protected from foreign matter, and the switch can be activated by moving a slide in a channel disposed lateral to the housing-interior, whereby the spring contact plate is deflected by way of an actuating bracket which is pivotably mounted in the switch housing at one end and penetrates the side of the housing-interior facing the channel at the other end by means of an angled section.

### BACKGROUND OF THE INVENTION

The present invention relates to a dustproof and waterproof switch, which is used in particular in a seat belt buckle of restraint systems in motor vehicles for indicating that the latch plate of the seat belt, which is inserted into the buckle, is properly locked.

A seat belt buckle latch mechanism having a microswitch equipped for fail-safe polling is known from DE 43 38 485 A1, wherein the microswitch is coupled to two functional parts that, independently of each other, are involved in the locking process of the latch mechanism in such a way that the microswitch assumes the closed position, which is configured to trigger additional functional elements of the safety device, only if the two functional parts of the latch mechanism are simultaneously in the locked position.

Moreover, a switch that is used in seat belt buckles is known from Eduard Hartmann GmbH, This switch is a twin-contact switch, the contact springs or tongues of which are seated against the contact points when they are not loaded, and establish contact. One of the two tongues is designed as a twin-contact tongue, so as to increase the switching reliability. The switch is designed so as to be laterally disposed in the seat belt buckle housing, and more particularly such that a slide made of an insulating material is pushed between the contact tongues when the latch plate is inserted. This slide remains between the contact tongues of the switch after the latch plate has engaged, thereby separating the contact. This indicates that the seat belt has been fastened and properly locked in the buckle.

Since the switch includes a housing that is open at the top so as to allow a movement of the slide made of an insulating material between the contact tongues, it is possible that foreign matter, such as liquids or solid particles, can penetrate from the outside through the opening of the seat belt buckle housing.

This may cause the safety function to become impaired, since contact separation may erroneously signal proper locking of the latch plate in the buckle.

The contact tongues are designed to be outwardly curved in the upper region so as to facilitate an insertion of the slide between the contact zones, This results in an approximate V shape in the upper region. Penetrating foreign matter deposits in this region and is then moved directly into the contact region by the slide,

Additionally, automated assembly during production is not possible with this switch, since the contact tongues must be connected to appropriate cables before they are inserted into the switch housing, and the switching tongues are designed so that they are under a certain preload after installation. With the cables connected, the contact tongues must essentially be inserted manually into the switch housing.

U.S. Pat. No. 6,002,325 discloses a unit for signaling the fastening status of seat belts. The unit comprises a printed circuit board, which is populated with electronic components and spring-loaded contact plates for a switch. The printed circuit board is mounted in a housing, which is attached to an exterior surface of the seat belt buckle. A pivoting lever (flipper element) is mounted on a pin in the housing and, during insertion of the latch plate into the seat belt buckle, is rotated counter to the action of a coil spring into the contact space of the signaling unit, as a result of an edge of the latch plate sliding on a sliding surface of the pivoting lever, and switches the contacts.

Since the longitudinal insertion movement of the latch plate cannot be directly used for switching the contacts, but must be converted into a direction that is approximately perpendicular thereto by way of the pivoting lever, the risk of high wear on the sliding surface of the pivoting lever due to a possible burr on the sliding edge of the latch plate arises over the course of the life cycle, which can impair the switching function.

Since the pivoting lever protrudes lateral to the switch housing, the lever may be destroyed by external influences (break off), such that a proper indication of the fastening status is no longer assured.

While the contact zones of the contact plates are protected by the housing from dirt particles falling in, liquids that drip in from above can be introduced into the contact zones by way of the pivoting lever, particularly through the opening that is present in the housing for the pivoting lever, and this can result in contact faults.

Fatigue of the coil spring over the course of the service life and collection of dust and liquids at the bearing point of the pivoting lever, and the resulting sluggishness thereof, can likewise prevent reliable switching of the contacts.

The need to use the pivoting Sever and coil spring makes the switch expensive.

By mounting the signaling unit on an exterior surface of the seat belt buckle, the space requirement for the buckle is increased. The interference fit of the signaling unit on the belt buckle can be impaired by climate, temperature and external mechanical stresses. Additionally, there is the risk that the pivoting lever, which is relatively easy to access from the outside, may be damaged due to improper handling by the user.

Given the relatively complicated shape of the switch contacts, automatic mounting on the printed circuit board is very difficult. Moreover, the production volume of a particular model is limited by the integration of the switch contacts into the signaling unit, since the specification of the signaling unit is dependent on the automobile, which consequently likewise makes automated production more difficult,

U.S. Pat. No. 4,163,128 describes a safety buckle having a switch, which is composed of two spring-loaded contact plates, the ends of which are in contact with each other when the latch plate is not inserted. Switching is carried out by way of two curved cam surfaces located on a turning actuator that is mounted on a post of the buckle housing. The actuator is turned by the latch plate, during insertion of the same into the belt buckle, counter to the action of a coil spring, so that the curved cam surfaces consecutively deflect the ends of the contact plates, and thereby open the contact. The rotation is achieved by way of an upright post on the actuator, the post becoming engaged with the latch plate. Switching back takes place by independent restoration of the actuator as a result of the action of the coil spring and the rebound of the contact plates after the latch plate has been pulled, The contact plates are integrated into the seat belt buckle, but not into a separate switch housing.

Again, the longitudinal insertion movement of the latch plate cannot be used directly for switching the contacts. An additional deflecting part in the form of a turning actuator having a coil spring is required. As a result, the switch becomes more expensive.

The contacts and the turning actuator are not protected against dirt particles falling in or liquids dripping in. The result can be malfunctions due to contact soiling and limitation of the mobility of the turning actuator due to dirt accumulation on the post mounting. Malfunctions can also occur due to fatigue or breakage of the coil spring over the course of the service life.

Automated installation of the contact plates in the housing is not feasible, since no option is provided for connecting the lines to the contact plates after insertion of the same into the housing, and the contact plates consequently must be connected to the connecting lines prior to insertion,

A switch for a seat belt buckle having two contact plates is known from EP 1 485 276 B1, wherein a first contact plate is designed, toward the first contacting end thereof, as a twin-contact tongue, and a second contact plate is designed as a contact spring having a hammer-shaped region at the contacting end. The contacting regions of the two contact plates are located in an upper housing-interior space of the switch housing, this space being substantially protected from foreign matter. Beneath this space, the contact spring includes a curved region which, through a corresponding opening in the switch housing, protrudes into a channel that is disposed lateral to the housing-interior and forms part of the switch. During insertion of the latch plate into the seat belt buckle, a slide forming part of the buckle is moved into this channel and meets with the curved region of the contact spring which projects into the channel. As a result, the contact spring is deflected counter to the resilience thereof in the direction of the housing-interior, and the electric switching operation at the contacting end of the contact spring, together with the twin-contact tongue of the first contact plate, is effected. The switch can be designed as a normally closed contact or a normally open contact.

Due to the opening in the switch housing, which is required for leading the curved region of the contact spring out of the housing-interior, dust protection for the housing-interior, and thus for the contacting regions of the two contact plates located therein, is impossible.

Moreover, due to the necessary directional deflection of the longitudinal force acting on the curved region of the contact spring by way of the slide into a lateral force that is required for the deflection of the contact spring, deformation of the curved region of the contact spring due to frictional forces as the slide impinges onto this region cannot be precluded, when there are tolerance-induced maximum values for the thickness of the slide as well as the degree of protrusion of the curved region of the contact spring into the channel disposed lateral to the housing-interior, if the friction force is further increased by foreign matter having penetrated from the outside into the belt buckle. As a result, in extreme cases, the switch function may be impaired.

### SUMMARY OF THE INVENTION

Therefore, it is the object of the invention to design a dustproof and waterproof switch, which is used in particular in. a seat belt buckle of restraint systems of motor vehicles, and indicates that the latch plate of the seat belt which is inserted into the belt buckle is properly locked, in such a way that the contact region is substantially protected from penetrating foreign matter, and so as to be suitable for fully automatic assembly during production of the switch, with subsequent substantially automated connection of the cable.

According to the invention, the object is achieved in that the dustproof and waterproof switch, in particular for a seat belt buckle of restraint systems of motor vehicles, for indicating that the latch plate has been inserted into the buckle and properly locked, is provided with two contact plates, wherein the contacting regions of the contact plates are disposed in a housing-interior of the switch housing, which is protected from foreign matter, and the contact can be switched by moving a slide in a channel disposed lateral to the housing-interior. The contact plates, comprising a fixed contact plate and a contact spring plate, can be switched by way of an actuating bracket, wherein the angled section of the actuating bracket penetrates the lateral wall of the housing-interior facing the channel, and the other end of the bracket is pivotably mounted in the switch housing. The recess for the pivot mounting of the actuating bracket is disposed physically separated from the housing-interior.

The actuating bracket, which is composed of a planar rectangular metal strip having a semi-circular region integrally formed at one end and a double bend present in the same direction at the other end, transmits the force necessary for switching to the contact spring, wherein the semi-circular region, together with a matching recess in the switch housing, forms a pivot mount for the actuating bracket and, with the aid of the first bend, the other end of the actuating bracket is guided through a gap in the lateral wall of the housing-interior facing the channel and into this channel and, due to the second bend, limits the pivoting movement of the actuating bracket in the direction of the channel, As a result of the movement of the slide into the channel, the contact spring plate is deflected by way of the end of the actuating bracket protruding into the housing-interior, whereby switching of the contacts is effected. The actuating bracket can also be made of a spring wire.

The angled section of the actuating bracket is guided through a gap, whereby the penetration of dust or water can be reliably minimized.

By attaching a diaphragm made of a pliable plastic material in the region of the angled section of the actuating bracket, an absolutely dustproof and waterproof design of the switch can be achieved, wherein the diaphragm seals the gap through which the angled section of the actuating bracket passes.

Securing the positioning of the actuating bracket so as to prevent the same from becoming detached from the switch housing, and sealing the housing-inferior against the penetration of foreign matter, are achieved by a housing cover mounted on the upper side of the switch housing.

The contact spring plate is deflected transversely to the longitudinal direction thereof in the housing-interior by the actuating bracket, whereby deformation is prevented.

The contact spring plate can be designed as a substantially flat bending part, which has an advantageous effect for automated assembly during production of the switch.

Because the length of the actuating bracket can be substantially freely selected for the switching function, the bevel of the bracket for the slide can be relatively flat, so that the pushing force to be applied by the slide for actuating the switch can be kept low. Furthermore, for this purpose, a material, or a surface layer, having good sliding properties may additionally be selected for the actuating bracket, regardless of the surface layer that is required for the electrical function of the contact spring plate.

The invention will be described in more detail based on one exemplary embodiment.

### BRIEF DESCRIPTION OF THE DRAWINGS

In the drawings:

FIG. 1 shows a switch in the non-actuated state;

FIG. 2 shows a switch in the actuated state; and

FIG. 3 shows the configuration of the contacts/actuating bracket.

### DETAILED DESCRIPTION OF THE INVENTION

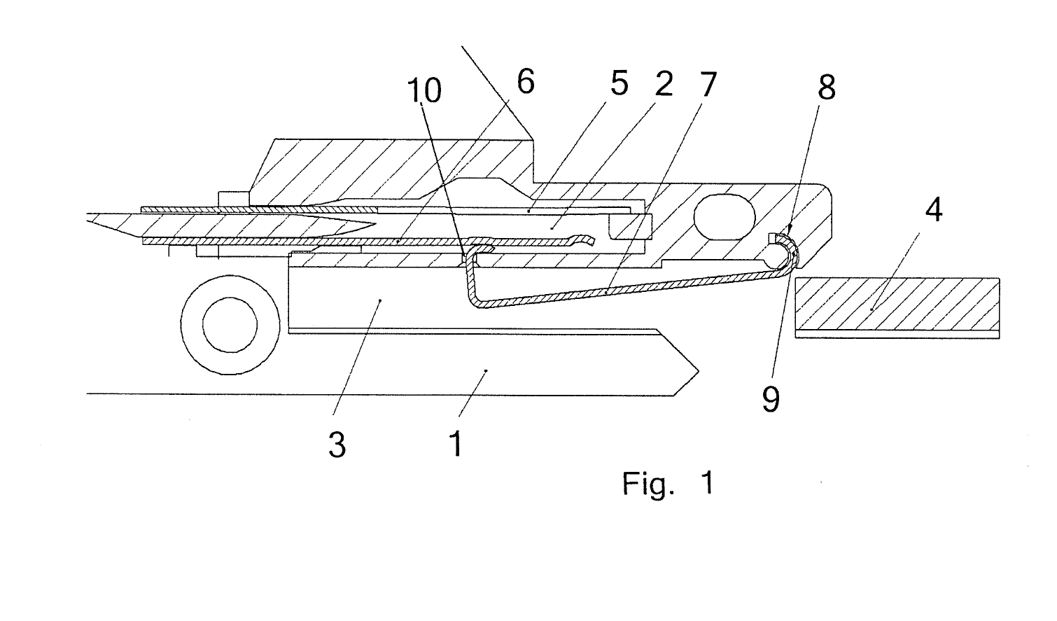

FIG. 1 shows a sectional view of the switch according to the invention in the non-actuated state. The switch, which is designed as a normally open contact, comprises the switch housing 1, which is closed by way of a cover (not shown here). The switch has a closed housing-interior 2, which accommodates the fixed contact plate 5 and the contact spring plate 8 and is open toward the channel 3 only via a gap 10, A connecting space is provided in the lower region of the switch, the fixed contact plate 5 and the contact spring plate 8 ending in this space. These may be connected to the connecting lines here.

At one end, the actuating bracket 7 is pivotably mounted in a recess 8 by way of a semi-circular region 9. At the other end, the angled section 13 penetrates the gap 10, and the curved end region 14 thereof is seated on the contact spring plate 8, The curved end region 14 prevents the angled section 13 from sliding out of the gap 10.

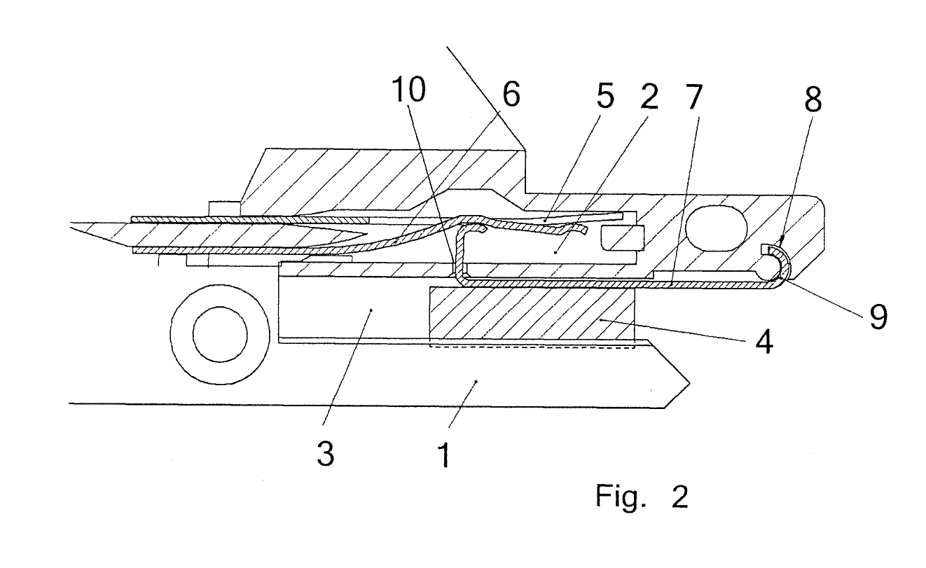

The actuating bracket 7 is pushed in the direction of the channel wall on the contact space side by a downward motion of the slide 4 in the channel 3 resulting from the insertion of the latch plate into the seat belt buckle. In this process, the curved end region 14 pushes onto the contact spring plate 8 and thereby closes the contact. FIG. 2 shows the switch in the actuated state.

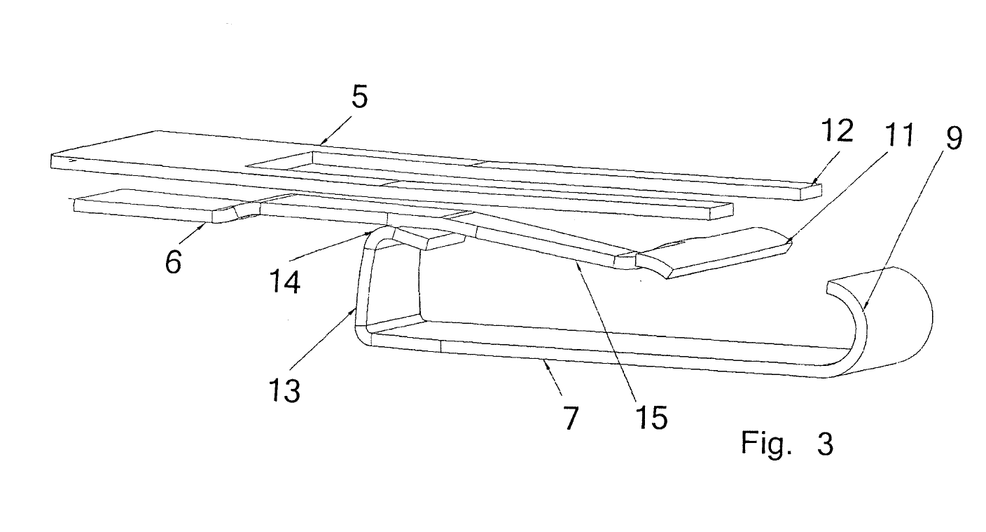

FIG. 3 shows an exploded view of the contacts and of the actuating bracket 7.

The fixed contact plate 5 is provided with contact tongues 12, while the contact spring plate is provided with a narrow land region 15 and a hammer-shaped region 11 disposed at the end. The hammer-shaped region 11 of the contact spring plate 6 on both sides forms the contact surfaces with the contact tongues 12 of the fixed contact plate 5, and thus the two contact points of the switch. The contact spring plate 6 is under bending stress both in the contacted state and in the non-contacted state. In the non-actuated state, the angled section of the actuating bracket 7 is pushed back into the channel 3 as a result of the bending stress.

The switch thus designed can be assembled fully automatically. The fixed contact plate 5, the contact spring plate 8 and the actuating bracket 7 can be inserted, using appropriate assembly machines. After the switch housing 1 is closed by way of a cover, the switch can be tested in terms of the function thereof. Thereafter, the connecting lines can be attached. This is done in a substantially automated fashion by way of crimping or welding, since the housing 1 is open on both sides in the region of the connecting space.

The housing-interior 2 is closed except for the gap 10, through which the angled section 13 of the actuating bracket 7 penetrates, so that foreign matter, such as dust and water, cannot penetrate into the contact region. As a result, protection from functional failures due to soiling is assured.

1. A dustproof and waterproof switch for a seat belt buckle of restraint systems of motor vehicles, for indicating that a latch plate has been inserted into the seat belt buckle and properly locked, the dustproof and waterproof switch comprising
two contact plates having contracting regions disposed in a housing-interior of a housing of the switch, the housing-interior being closed off from foreign matter, and
a slide movable in a channel disposed lateral to the housing-interior,
the contact plates comprise a fixed contact plate and a contact spring plate,
an actuating bracket extends into the channel and is pivotably mounted at a section thereof at one end of the actuating bracket,
the actuating bracket has, at an end thereof opposite said one end, an angled section which angles toward the housing-interior and penetrates a wall of the housing-interior which faces the channel, and
the contact spring plate is engageable by the slide and is urged by the slide into contact with fixed contact spring as the slide is moved along the channel in a direction from the pivotably mounted end section of the actuating bracket toward the angled section end of the actuating bracket.

2. The dustproof and waterproof switch according to
wherein
the actuating bracket comprises a rectangular metal strip having a semi-circular region integrally formed at one end thereof, thereby constituting the pivotably mounted end section of the actuating bracket and an angled section integrally formed at the opposite end thereof, thereby constituting the angled section of the actuating bracket.

3. The dustproof and waterproof switch according to claim 1,
wherein
the angled section is curved.

4. The dustproof and waterproof switch according to claim 3,
wherein
the actuating bracket is pivotably mounted by the semi-circular region being pivotably mounted in a recess in the switch housing.

5. The dustproof and waterproof switch according to claim 3,
wherein
the recess for the pivotable mounting of the actuating bracket is external to the housing-interior.

6. The dustproof and waterproof switch switch according to claim 1,
wherein
the angled section of the actuating bracket penetrates said wall of the housing interior through a gap in said wall.

7. The dustproof and waterproof switch according to claim 1, wherein
the actuating bracket is provided with a diaphragm made of a pliable plastic material in the region of the angled section.

8. A dustproof and waterproof switch according to claim 1, wherein
positioning of the actuating bracket is secured by a cover mounted on an upper side of the switch housing.
